(19) United States
(12) Patent Application Publication
(10) Pub. No.: US 2011/0223511 A1
(43) Pub. Date: Sep. 15, 2011

(54) FUEL CELL STACK WITH UNIFORM GAS DISTRIBUTION IN MAIN FLOW CHANNELS THEREOF

(75) Inventors: Po-Hsien Chou, Kwei Shan Township (TW); Chi-Bin Wu, Kwei Shan Township (TW)

(73) Assignee: Chung-Hsin Electric and Machinery Manufacturing Corp., Jhonghe City (TW)

(21) Appl. No.: 12/791,132

(22) Filed: Jun. 1, 2010

(30) Foreign Application Priority Data
Mar. 12, 2010 (TW) 099107367

(51) Int. Cl. H01M 8/24

(52) U.S. Cl. 429/456

(57) ABSTRACT

A fuel cell stack with uniform gas distribution in main flow channels thereof includes a cell stack and an anti-eddy current unit. The cell stack is composed of a plurality of cell units and has an admission flow channel for importing fuel gas. The anti-eddy current unit is provided in the cell stack and situated at the admission end of the admission flow channel to promote fuel gas distribution uniformly in the cell units, thereby increasing the electric power generation efficiency of the fuel cell stack.

### BACKGROUND OF THE INVENTION

1. Technical Field

The present invention relates to a fuel cell stack with uniform gas distribution in main flow channels thereof More particularly, the present invention relates to a fuel cell stack capable of increasing the uniformity of fuel gas distribution in its main flow channels.

2. Description of Related Art

A fuel cell is a device for generating electric power by electrochemical reactions. Fuel gas and air fed into a fuel cell are turned into electric current and water as chemical energy is converted into electricity. Since fuel cells have a high capacity for generating power, and they are also relatively non-toxic for the human body and the environment, they have therefore grabbed the world's attention as a new-generation alternative energy source.

FIG. 1 schematically shows gas distribution in a conventional fuel cell stack 100, particularly the entry of high-velocity fuel gas into a main flow channel 31 of the fuel cell stack 100.

As shown in FIG. 1, the fuel cell stack 100 is composed of a plurality of cell units 11 stacked together, wherein each cell unit 11 has its own gas flow channels. After the cell units 11 are stacked up to form the fuel cell stack 100, two main flow channels 31, 32 and a plurality of branch flow channels 33 take shape. The main flow channels 31, 32 are the main conduits through which fuel gas enters and exits the fuel cell stack 100, respectively. More specifically, the main flow channel 31 is the admission flow channel (into which fuel gas is input in a direction indicated by the straight arrow in the drawing), and the main flow channel 32 is the discharge flow channel. Fuel gas flows into the admission flow channel 31 and passes through the branch flow channels 33 before entering each cell unit 11, where electrochemical reactions take place.

Due to the fuel cell stack 100 operating at high power, it is necessary to pump a large amount of fuel gas into the fuel cell stack 100. However, the flow velocity of the fuel gas then becomes so elevated that a high-velocity flow occurs, especially upon entry of the fuel gas into the admission flow channel 31. Therefore, eddy currents 40 and consequently a negative pressure may be generated at the admission end of the admission flow channel 31. When this occurs, the fuel gas in the cell units 11 adjacent to the admission end will be drawn out so as to prevent the fresh fuel gas from entering these cell units 11 effectively. As a result, the electric power generation efficiency of the affected cell units 11 is decreased.

In addition, the faster the fuel gas enters the admission end of the admission flow channel 31, the more extensively the eddy currents 40 will develop, and the more significant the adverse effects on the electric power generation efficiency of the cell units 11 will be. As the eddy currents 40 cause uneven gas distribution in the admission flow channel 31, not only is the electric power generation efficiency of the cell units 11 at the admission end lowered, but also the performance of the entire fuel cell stack 100 is compromised.

### BRIEF SUMMARY OF THE INVENTION

It is an objective of the present invention to provide a fuel cell stack with uniform gas distribution in main flow channels thereof, wherein an anti-eddy current unit is provided at the admission end of an admission flow channel to effectively prevent the occurrence of eddy currents, which may otherwise cause uneven distribution of fuel gas in the admission flow channel. Thus, the overall electric power generation efficiency of the fuel cell stack is enhanced.

It is another objective of the present invention to provide a fuel cell stack with uniform gas distribution in main flow channels thereof, wherein a plurality of dummy cells are disposed at the admission end of an admission flow channel in lieu of certain cell units. The dummy cells can mitigate the impact of uneven fuel gas distribution on the electric power generation efficiency of the remaining cell units.

It is still another objective of the present invention to provide a fuel cell stack with uniform gas distribution in main flow channels thereof, wherein a baffle having a plurality of apertures is installed at the inlet of an admission flow channel. The apertures serve to prevent the occurrence of eddy currents, which may otherwise lower the electric power generation efficiency of the fuel cell stack.

To achieve the foregoing objectives, the present invention provides a fuel cell stack with uniform gas distribution in main flow channels thereof, wherein the fuel cell stack includes a cell stack and an anti-eddy current unit. The cell stack is composed of a plurality of cell units and has an admission flow channel. The anti-eddy current unit is provided in the cell stack and situated at an admission end of the admission flow channel.

To achieve the foregoing objectives, the present invention also provides a fuel cell stack with uniform gas distribution in main flow channels thereof, wherein the fuel cell stack includes: a cell stack composed of a plurality of cell units and having an admission flow channel; and an anti-eddy current unit composed of at least one dummy cell. The at least one dummy cell is integrated with the cell units and located at an admission end of the admission flow channel.

To achieve the foregoing objectives, the present invention further provides a fuel cell stack with uniform gas distribution in main flow channels thereof, wherein the fuel cell stack includes: a cell stack composed of a plurality of cell units and having an admission flow channel; and an anti-eddy current unit formed as a baffle. The baffle is provided at an inlet of the admission flow channel and has a plurality of apertures.

Implementation of the present invention at least involves the following inventive steps:

1. The anti-eddy current unit prevents eddy currents which may otherwise occur upon entry of high-velocity fuel gas. In consequence, the uniformity of fuel gas distribution in the admission flow channel is increased.

2. The admission of fuel gas is rendered uniform so that the electric power generation efficiency of the cell units adjacent to the admission end will not be compromised. Thus, the fuel cell stack is enabled for high-power operation.

The features and advantages of the present invention are detailed hereinafter with reference to the preferred embodiments. The detailed description is intended to enable a person skilled in the art to gain insight into the technical contents disclosed herein and implement the present invention accordingly. More particularly, a person skilled in the art can easily understand the objectives and advantages of the present invention by referring to the disclosure of the specification, the claims, and the accompanying drawings.

### BRIEF DESCRIPTION OF THE SEVERAL VIEWS OF THE DRAWINGS

FIG. 1 schematically shows the distribution of high-velocity fuel gas in the admission flow channel of a conventional fuel cell stack upon entry;

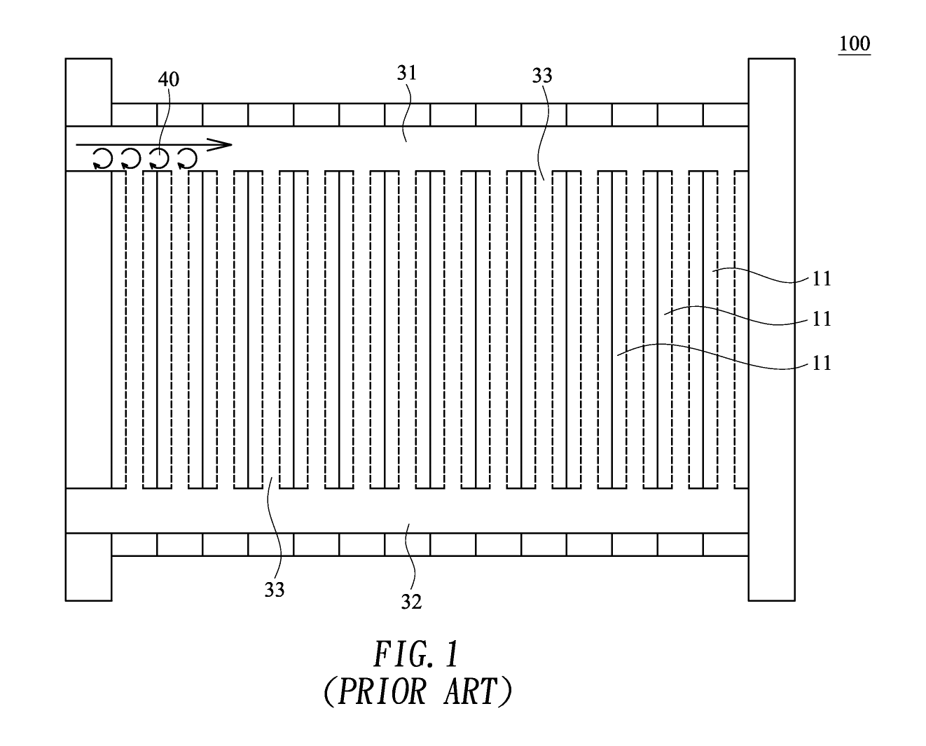

FIG. 2 shows a first aspect of a fuel cell stack with uniform gas distribution in main flow channels thereof according to the present invention;

FIG. 3 shows a second aspect of the fuel cell stack with uniform gas distribution in the main flow channels thereof according to the present invention; and

FIG. 4 schematically shows a honeycomb structure inside a baffle according to the present invention.

### DETAILED DESCRIPTION OF THE INVENTION

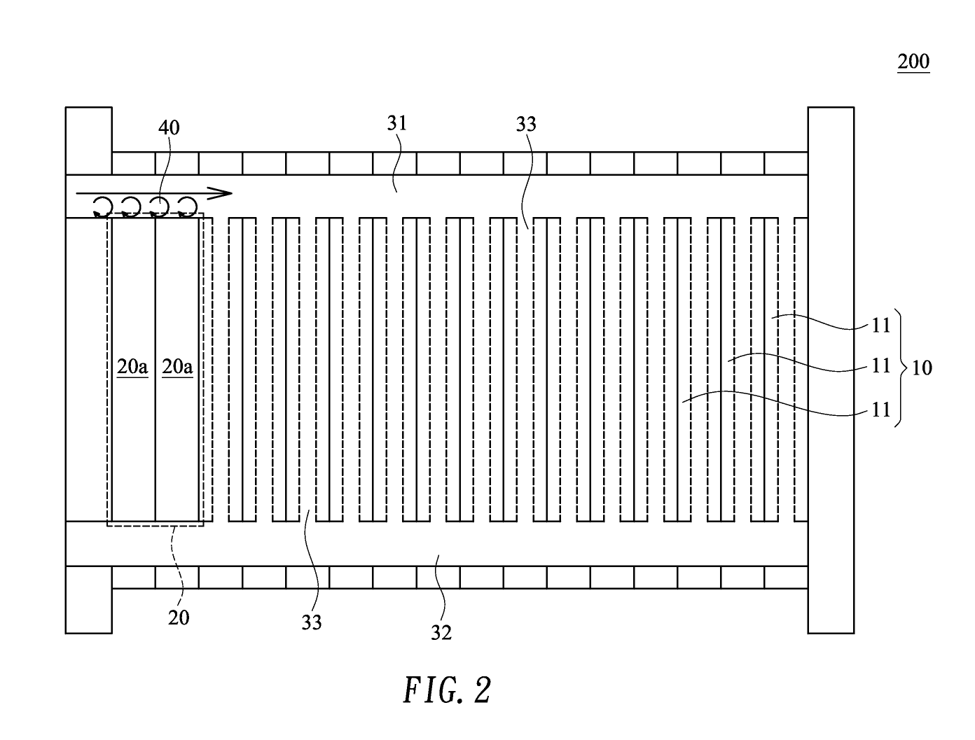

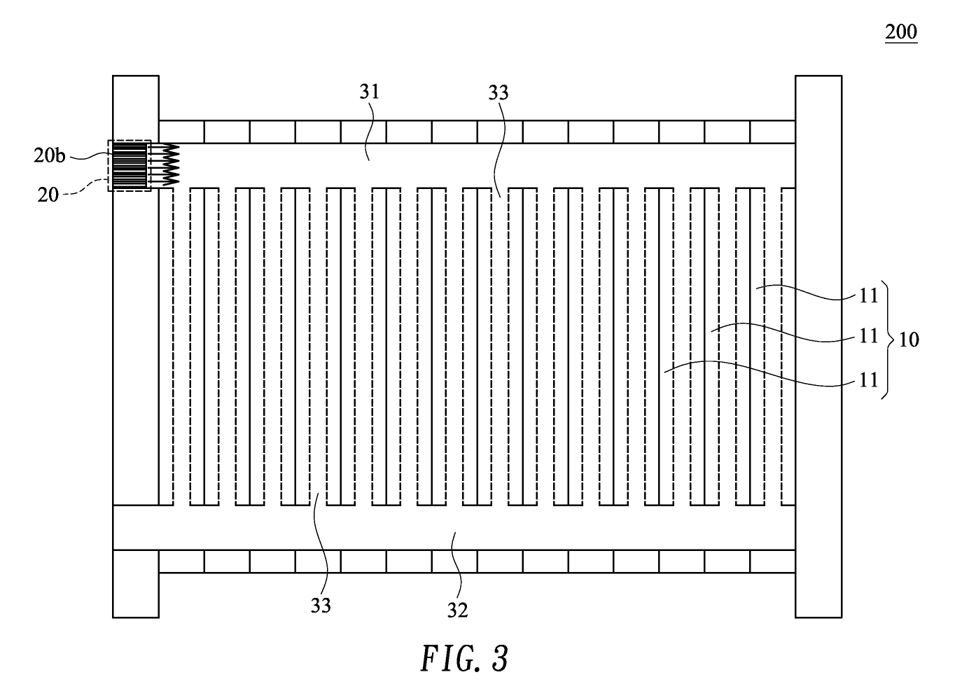

Referring to FIG. 2 and FIG. 3, a fuel cell stack 200 with uniform gas distribution in main flow channels thereof according to an embodiment of the present invention includes a cell stack 10 and an anti-eddy current unit 20.

The cell stack 10 is composed of a plurality of cell units 11, wherein each cell unit 11 has its own gas flow channels. After the cell units 11 are stacked together, an admission flow channel 31, a discharge flow channel 32, and a plurality of branch flow channels 33 are formed. The admission flow channel 31 and the discharge flow channel 32 are the main conduits through which fuel gas enters and exits the cell stack 10, respectively. The straight arrow in FIG. 2 indicates the direction in which fuel gas is input into the admission flow channel 31. The branch flow channels 33 are connected with the admission flow channel 31, thus allowing the fuel gas to enter each cell unit 11, where electrochemical reactions take place to generate electric power.

The anti-eddy current unit 20 is provided in the cell stack 10. In order to prevent the occurrence of eddy currents 40 which may otherwise result from a high-velocity fuel gas flow into the admission flow channel 31, the anti-eddy current unit 20 is disposed at an admission end of the admission flow channel 31. The anti-eddy current unit 20 may work passively or actively, depending on its configuration. More particularly, the anti-eddy current unit 20 may wait passively until the gas flow reaches a stable state. For instance, the cell units 11 which are in a region where eddy currents 40 tend to occur may be replaced by dummy cells 20a so as to mitigate the adverse effects of the eddy currents 40 on the cell units 11 located adjacent to the admission end. Alternatively, the anti-eddy current unit 20 may actively regulate the direction of gas flow so as to eliminate the possibility of occurrence of the eddy currents 40. For instance, a baffle 20b formed with a plurality of apertures 21 can be used to impede gas flow and thereby prevent the occurrence of the eddy currents 40.

Please refer to the following detailed description of a first and a second aspect of the present invention for application of the anti-eddy current unit 20.

### <First Aspect>

As shown in FIG. 2, the anti-eddy current unit 20 is composed of at least one dummy cell 20a. The dummy cells 20a are located at the admission end of the admission flow channel 31 and integrated with the cell units 11 to form a portion of the cell stack 10. The number of the dummy cells 20a is determined by the extent to which the eddy currents 40 may develop, so that the eddy currents 40 only take place in the vicinity of the dummy cells 20a, which thereby allows the fuel gas flowing past the cell units 11 to distribute uniformly in the admission flow channel 31. Due to the dummy cells 20a, the uneven fuel gas distribution caused by the eddy currents 40 are prevented from affecting the electric power generation efficiency of the cell units 11 adjacent to the admission end.

According to the first aspect of the present invention, the dummy cells 20a are used as the anti-eddy current unit 20 and are provided at the admission end where the eddy currents 40 are likely to occur. The dummy cells 20a replace certain cell units 11 to reduce the adverse effects of uneven fuel gas distribution on the electric power generation efficiency of the cell units 11.

### <Second Aspect>

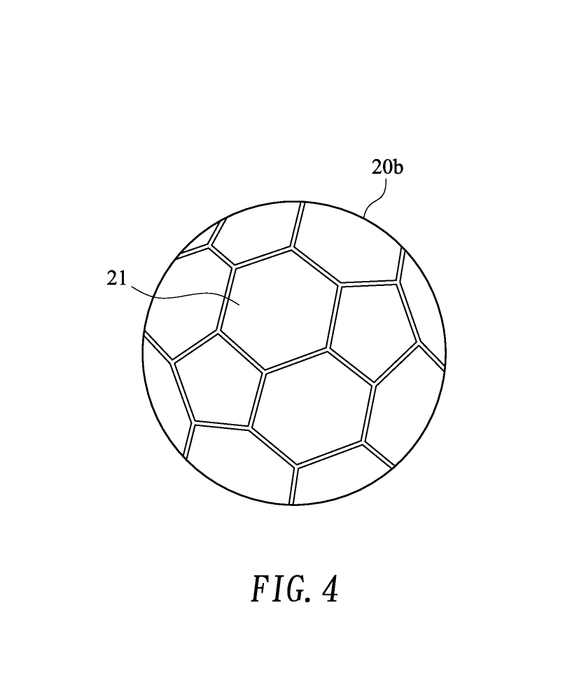

Referring to FIG. 3 and FIG. 4, the anti-eddy current unit 20 is formed as a baffle 20b having a plurality of apertures 21. The baffle 20b is located at the inlet of the admission flow channel 31. The baffle 20b may be formed of metal wool, which is a porous metal product. Alternatively, the apertures 21 of the baffle 20b may form a honeycomb structure inside the baffle 20b, as shown in FIG. 4. Regardless of whether the baffle 20b is formed of metal wool or has apertures 21 forming a honeycomb structure, the baffle 20b serves to regulate the flow direction of fuel gas and thereby prevent the development of the eddy currents 40 at the inlet of the admission flow channel 31. Hence, baffles 20b of different thicknesses and different porosities can be used according to the design of the cell stack 10.

According to the second aspect of the present invention, the baffle 20b with a plurality of apertures 21 is used as the anti-eddy current unit 20. When fuel gas passes through the baffle 20b, the flow direction of the fuel gas is regulated to prevent the occurrence of the eddy currents 40 and promote uniform fuel gas distribution in the admission flow channel 31.

The foregoing embodiments are provided to demonstrate the features of the present invention so that a person skilled in the art can understand the contents disclosed herein and implement the present invention accordingly. The embodiments, however, are not intended to limit the scope of the present invention, which is defined only by the appended claims. Therefore, all equivalent changes or modifications which do not depart from the spirit of the present invention should fall within the scope of the appended claims.

What is claimed is:

1. A fuel cell stack with uniform gas distribution in main flow channels thereof, comprising:
a cell stack composed of a plurality of cell units and having an admission flow channel; and
an anti-eddy current unit provided in the cell stack and located at an admission end of the admission flow channel.

2. The fuel cell stack of claim 1, wherein the anti-eddy current unit is composed of at least one dummy cell, and the at least one dummy cell is integrated with the cell units.

3. The fuel cell stack of claim 1, wherein the anti-eddy current unit is a baffle provided at an inlet of the admission flow channel and having a plurality of apertures.

4. The fuel cell stack of claim 3, wherein the baffle is made of metal wool.

5. The fuel cell stack of claim 3, wherein the apertures form a honeycomb structure in the baffle.

6. A fuel cell stack with uniform gas distribution in main flow channels thereof, comprising:
a cell stack composed of a plurality of cell units and having an admission flow channel; and
an anti-eddy current unit composed of at least one dummy cell, wherein the at least one dummy cell is integrated with the cell units and provided at an admission end of the admission flow channel.

7. A fuel cell stack with uniform gas distribution in main flow channels thereof, comprising:
a cell stack composed of a plurality of cell units and having an admission flow channel; and
an anti-eddy current unit formed as a baffle, wherein the baffle is provided at an inlet of the admission flow channel and has a plurality of apertures.

8. The fuel cell stack of claim 7, wherein the baffle is made of metal wool.

9. The fuel cell stack of claim 7, wherein the apertures form a honeycomb structure in the baffle.
